(19) United States
(12) Patent Application Publication
(10) Pub. No.: US 2025/0154439 A1
(43) Pub. Date: May 15, 2025

(54) A LAUNDRY SCENTING COMPOSITION

(71) Applicant: Dow Silicones Corporation, Midland, MI (US)

(72) Inventors: Serge Creutz, Liege (BE); Rahma Benbakoura, Quaregnon (BE); Saugata Nad, Brussels (BE); Jacqueline L'hostis, Silly (BE); Flore Vandemeulebroucke, Manage (BE)

(21) Appl. No.: 18/728,474

(22) PCT Filed: Jan. 19, 2023
(86) PCT No.: PCT/US2023/011094

§ 371 Date: Jul. 12, 2024

Related U.S. Application Data
(60) Provisional application No. 63/303,111, filed on Jan. 26, 2022.

(51) Int. Cl. C11D 3/22; C11D 3/50; C11D 17/06

(52) U.S. Cl. CPC C11D 3/225; C11D 3/505; C11D 17/06; C11D 2111/12; C11D 2111/40

(57) ABSTRACT

A laundry scenting composition is provided, including water; a solid carrier; a crosslinked cellulose ether containing 0.1 to 0.6 wt %, based on weight of the crosslinked cellulose ether, of polyether groups; and a scent additive; wherein the laundry scenting composition is a solid.

The present invention relates to a laundry scenting composition. In particular, the present invention relates to a laundry scenting composition, comprising: water, a solid carrier; a crosslinked cellulose ether containing 0.1 to 0.6 wt %, based on weight of the crosslinked cellulose ether, of polyether groups; and a scent additive; wherein the laundry scenting composition is a solid.

For decades consumers have sought to add fragrance to laundry during the cleaning process. An array of scented fabric conditioners are currently on the market for consumers.

Such products typically combine perfumes with softening and conditioning agents to impart benefits to laundry such as a fresh smell, softness, static free, crease free or easier ironing.

Some consumers desire additional scenting benefits. Such consumers have been referred to as scent seekers and have been known to over dose laundry products such as laundry detergent and fabric softener in an effort to impart a desired freshness to their laundry. There remains a need to provide scent delivery products to consumers that provide enhanced freshness to laundry. Such scenting compositions should be able to be applied by the consumer, independent of other laundry products, to achieve the laundry scent level desired by the individual consumer in a cost effective manner.

Laundry scent additives are disclosed by Aouad in U.S. Pat. No. 9,453,189 to enable consumers to control the amount of scent imparted to their laundry. Aouad discloses a composition comprising a plurality of pastilles, said pastilles comprising: (a) polyethylene glycol; and (b) friable perfume microcapsules, wherein said perfume microcapsules comprise encapsulated perfume; wherein each of said pastilles has a mass from about 0.95 mg to about 2 g; and wherein each of said pastilles has a shape of hemispherical or compressed hemispherical.

Notwithstanding, there remains a need for new laundry scenting additives. In particular, it would be desirable to substitute some of the solid carrier in the scenting additive with water to reduce the cost of conventional laundry scenting compositions, while retaining the structural and scent delivery properties associated with such systems.

The present invention provides a laundry scenting composition, comprising: 5 to 40 wt %, based on weight of the laundry scenting composition, of water; 35 to 93.95 wt %, based on weight of the laundry scenting composition, of a solid carrier; 0.05 to 5 wt %, based on weight of the laundry scenting composition, of a crosslinked cellulose ether containing 0.1 to 0.6 wt %, based on weight of the crosslinked cellulose ether, of polyether groups; and 1 to 25 wt %, based on weight of the laundry scenting composition, of a scent additive; wherein the laundry scenting composition is a solid.

The present invention provides a laundry scenting composition, comprising: 5 to 40 wt %, based on weight of the laundry scenting composition, of water; 35 to 93.95 wt %, based on weight of the laundry scenting composition, of a solid carrier; 0.05 to 5 wt %, based on weight of the laundry scenting composition, of a crosslinked cellulose ether containing 0.1 to 0.6 wt %, based on weight of the crosslinked cellulose ether, of polyether groups; and 1 to 25 wt %, based on weight of the laundry scenting composition, of a scent additive; wherein the laundry scenting composition is a solid and wherein the crosslinked cellulose ether is an irreversibly crosslinked cellulose ether.

The present invention provides a laundry scenting composition, comprising: (a) 5 to 40 wt %, based on weight of the laundry scenting composition, of water; (b) 35 to 93.95 wt %, based on weight of the laundry scenting composition, of a solid carrier; (c) 0.05 to 5 wt %, based on weight of the laundry scenting composition, of a crosslinked cellulose ether containing 0.1 to 0.6 wt %, based on weight of the crosslinked cellulose ether, of polyether groups; (d) 1 to 25 wt %, based on weight of the laundry scenting composition, of a scent additive; and (e) 0.008 to <0.1 wt %, based on weight of the laundry scenting composition, of a drainage aid component; wherein the drainage aid component comprises: (i) 40 to 99 wt %, based on weight of the drainage aid component, of an organopolysiloxane comprising: 0 to 60 mol % of units of formula I and 40 to 100 mol % of units of formula II

Rₓ¹SiO_{(4-x)/2} (I)

R_{y}¹R_{z}²SiO_{(4-y-z)/2} (II)

wherein x is selected from the group consisting of 0, 1, 2 and 3; wherein y is selected from the group consisting of 0, 1 and 2; wherein z is selected from the group consisting of 1 and 2; with the proviso that y+z is 1, 2 or 3; wherein each R¹ is independently selected from a hydrogen, a hydroxy group and a group having 1 to 8 carbon atoms; wherein each R² is an -A_{c}R³ group; wherein A is a divalent linking group; wherein c is selected from the group consisting of 0 and 1; wherein each R³ is independently selected from a group having 9 to 35 carbon atoms; (ii) 1 to 30 wt %, based on weight of the drainage aid component, of an organosilicon resin; and (iii) 0 to 30 wt %, based on weight of the drainage aid component, of a hydrophobic additive; wherein the laundry scenting composition is a solid and wherein the crosslinked cellulose ether is an irreversibly crosslinked cellulose ether.

The present invention provides a method for scenting laundry comprising: dosing to the laundry washing machine or the laundry wash basin a laundry scenting composition according to the present invention; adding a fabric article to a laundry washing machine or a laundry wash basin; dosing water to the laundry washing machine or the laundry wash basin; and applying the water and the laundry scenting composition to the fabric article; wherein the scent additive comprises a perfume which is applied to the fabric article.

### DETAILED DESCRIPTION

It has been surprisingly found that with the addition of a crosslinked cellulose ether containing 0.1 to 0.6 wt %, based on weight of the crosslinked cellulose ether, of polyether groups; water can be substituted for some of the solid carrier used in laundry scenting compositions; while maintaining Shore A hardness of the composition and maintaining (or improving) the perfume delivery to laundry.

Unless otherwise indicated, ratios, percentages, parts, and the like are by weight. Weight percentages (or wt %) in the composition are percentages of dry weight, i.e., excluding any water that may be present in the composition. Percentages of monomer units in the polymer are percentages of solids weight, i.e., excluding any water present in a polymer emulsion.

As used herein, unless otherwise indicated, the terms “weight average molecular weight” and “Mw” are used interchangeably to refer to the weight average molecular weight as measured in a conventional manner with gel permeation chromatography (GPC) and conventional standards, such as polystyrene standards. GPC techniques are discussed in detail in Modem Size Exclusion Chromatography, W. W. Yau, J. J. Kirkland, D. D. Bly; Wiley-lnterscience, 1979, and in A Guide to Materials Characterization and Chemical Analysis, J. P. Sibilia; VCH, 1988, p. 81-84. Weight average molecular weights are reported herein in units of Daltons.

The term “DS” as used herein and in the appended claims means the number of alkyl substituted OH groups per anhydroglucose unit in a cellulose ether, as determined by the Zeisel Method.

The term “DS (methyl)” or “DS (M)” as used herein and in the appended claims means the number of methyl substituted OH groups per anhydroglucose unit in a cellulose ether, as determined by the Zeisel Method.

The term “MS” as used herein and in the appended claims means the number of moles of etherification reagent which are bound as ether per mol of anhydroglucose unit as hydroxyalkyl substituents in a cellulose ether, as determined by the Zeisel Method.

The term “MS (hydroxyethyl)” or “MS (HE)” as used herein and in the appended claims means the number of moles of etherification reagent which are bound as ether per mol of anhydroglucose unit as hydroxyethyl substituents in a cellulose ether, as determined by the Zeisel Method.

The term “MS (hydroxypropyl)” or “MS (HP)” as used herein and in the appended claims means the number of moles of etherification reagent which are bound as ether per mol of anhydroglucose unit as hydroxypropyl substituents in a cellulose ether, as determined by the Zeisel Method.

The term “Zeisel Method” refers to the Zeisel cleavage procedure for determination of MS and DS. See G. Bartelmus and R. Ketterer, Zeitschrift fuer Analytische Chemie, Vol. 286 (1977, Springer, Berline, DE), pages 161-190.

The term “solid” in reference to the laundry scenting composition of the present invention means that the laundry scenting composition does not perceptibly change shape when placed on a rigid surface and left to stand for 24 hours in air at 22° C., a relative humidity of 30-50% and a pressure of 101.4 kPa.

Preferably, the laundry scenting composition of the present invention, comprises: 5 to 40 wt % (preferably, 10 to 38 wt %; more preferably, 15 to 35 wt %; most preferably, 17 to 32 wt %), based on weight of the laundry scenting composition, of water; 35 to 93.95 wt % (preferably, 40 to 87.925 wt %; more preferably, 46 wt % to 80.9 wt %; most preferably, 52.4 to 76.85 wt %), based on weight of the laundry scenting composition, of a solid carrier; 0.05 to 5 wt % (preferably, 0.075 to 2 wt %; more preferably, 0.1 to 1 wt %; most preferably, 0.15 to 0.6 wt %), based on weight of the laundry scenting composition, of a crosslinked cellulose ether containing 0.1 to 0.6 wt %, based on weight of the crosslinked cellulose ether, of polyether groups (preferably, wherein the crosslinked cellulose ether is an irreversibly crosslinked cellulose ether); and 1 to 25 wt % (preferably, 2 to 20 wt %; more preferably, 4 to 18 wt %; most preferably, 6 to 15 wt %), based on weight of the laundry scenting composition, of a scent additive (preferably, wherein the scent additive is selected from the group consisting of a free perfume, a pro-perfume, an encapsulated perfume and mixtures thereof; more preferably, wherein the scent additive includes a mixture of a free perfume and an encapsulated perfume); wherein the laundry scenting composition is a solid (preferably, wherein the laundry scenting composition contains <3 wt % laundry actives).

Preferably, the laundry scenting composition of the present invention, comprises 5 to 40 wt % (preferably, 10 to 38 wt %; more preferably, 15 to 35 wt %; most preferably, 17 to 32 wt %), based on weight of the laundry scenting composition, of water; wherein the water is deionized water.

Preferably, the laundry scenting composition of the present invention, comprises: 35 to 93.95 wt % (preferably, 40 to 87.925 wt %; more preferably, 46 wt % to 80.9 wt %; most preferably, 52.4 to 76.85 wt %), based on weight of the laundry scenting composition, of a solid carrier; wherein the solid carrier is selected from the group consisting of polyethylene; polypropylene; copolymers of polyethylene and polypropylene; polyesters (e.g., polyethylene glycol); biodegradable polymers (e.g., polylactide and polyglycolic acid); polyurethanes; polyamides; polycarbonates; polysulfonates; polysiloxanes; polydienes (e.g., polybutylene, natural rubbers and synthetic rubbers); polyacrylates (e.g., polymethylmethacrylate); polystyrene; polyacrylonitrile butadiene styrene terpolymer; starch and mixtures thereof. More preferably, the laundry scenting composition of the present invention, comprises: 35 to 93.95 wt % (preferably, 40 to 87.925 wt %; more preferably, 46 wt % to 80.9 wt %; most preferably, 52.4 to 76.85 wt %), based on weight of the laundry scenting composition, of a solid carrier; wherein the solid carrier comprises polyethylene glycol (preferably, wherein the polyethylene glycol has a weight average molecular weight of 2,000 to 20,000 Daltons (preferably, 3,000 to 15,000 Daltons; more preferably, 4,000 to 12,000 Daltons; still more preferably, 5,000 to 11,000 Daltons; most preferably, 7,000 to 9,000 Daltons)). Still more preferably, the laundry scenting composition of the present invention, comprises: 35 to 93.95 wt % (preferably, 40 to 87.925 wt %; more preferably, 46 wt % to 80.9 wt %; most preferably, 52.4 to 76.85 wt %), based on weight of the laundry scenting composition, of a solid carrier; wherein the solid carrier comprises 50 to 100 wt % (preferably, 55 to 95 wt %; more preferably, 60 to 95 wt %; most preferably, 65 to 92.5 wt %), based on weight of the solid carrier, of polyethylene glycol (preferably, wherein the polyethylene glycol has a weight average molecular weight of 2,000 to 20,000 Daltons (preferably, 3,000 to 15,000 Daltons; more preferably, 4,000 to 12,000 Daltons; still more preferably, 5,000 to 11,000 Daltons; most preferably, 7,000 to 9,000 Daltons)); and 0 to 50 wt % (preferably, 5 to 45 wt %; more preferably, 5 to 40 wt %; most preferably, 7.5 to 35 wt %), based on weight of the solid carrier, of starch. Most preferably, the laundry scenting composition of the present invention, comprises: 35 to 93.95 wt % (preferably, 40 to 87.925 wt %; more preferably, 46 wt % to 80.9 wt %; most preferably, 52.4 to 76.85 wt %), based on weight of the laundry scenting composition, of a solid carrier; wherein the solid carrier is a polyethylene glycol (preferably, wherein the polyethylene glycol has a weight average molecular weight of 2,000 to 20,000 Daltons (preferably, 3,000 to 15,000 Daltons; more preferably, 4,000 to 12,000 Daltons; still more preferably, 5,000 to 11,000 Daltons; most preferably, 7,000 to 9,000 Daltons)).

Optionally, the solid carrier may comprise a low molecular weight polyethylene glycol to tailor certain properties of the solid carrier, such as, viscosity, melting point and water solubility. Preferably, the low molecular weight polyethylene glycol has a weight average molecular weight of 200 to 600 Daltons (preferably, 300 to 500 Daltons; more preferably, 350 to 475 Daltons; most preferably, 375 to 425 Daltons).

The polyethylene glycol used in the solid carrier may optionally include monomers other than ethylene oxide, in particular at low levels. Examples of such other monomers include other alkylene oxides (e.g., propylene oxide), glycidyl and other epoxide containing monomers, formaldehyde, organic alcohols and polyol monomers. Such other monomers can be included in the polyethylene glycol provided that the resulting material is solid at room temperature.

Preferably, the laundry scenting composition of the present invention, comprises: 0.05 to 5 wt % (preferably, 0.075 to 2 wt %; more preferably, 0.1 to 1 wt %; most preferably, 0.15 to 0.6 wt %), based on weight of the laundry scenting composition, of a crosslinked cellulose ether containing 0.1 to 0.6 wt %, based on weight of the crosslinked cellulose ether, of polyether groups. More preferably, the laundry scenting composition of the present invention, comprises: 0.05 to 5 wt % (preferably, 0.075 to 2 wt %; more preferably, 0.1 to 1 wt %; most preferably, 0.15 to 0.6 wt %), based on weight of the laundry scenting composition, of a crosslinked cellulose ether containing 0.1 to 0.6 wt %, based on weight of the crosslinked cellulose ether, of polyether groups; wherein the crosslinked cellulose ether comprises a base cellulose ether and crosslinks; wherein the crosslinks contain the polyether groups and wherein the base cellulose ether is a mixed cellulose ether containing hydroxyalkyl ether groups and alkyl ether groups. Still more preferably, the laundry scenting composition of the present invention, comprises: 0.05 to 5 wt % (preferably, 0.075 to 2 wt %; more preferably, 0.1 to 1 wt %; most preferably, 0.15 to 0.6 wt %), based on weight of the laundry scenting composition, of a crosslinked cellulose ether containing 0.1 to 0.6 wt %, based on weight of the crosslinked cellulose ether, of polyether groups; wherein the crosslinked cellulose ether comprises a base cellulose ether and crosslinks; wherein the crosslinks contain the polyether groups and wherein the base cellulose ether is selected from the group consisting of hydroxyethyl methylcellulose, hydroxypropyl methyl cellulose, methyl hydroxyethyl hydroxypropylcellulose, ethyl hydroxyethyl cellulose and combinations thereof. Most preferably, the laundry scenting composition of the present invention, comprises: 0.05 to 5 wt % (preferably, 0.075 to 2 wt %; more preferably, 0.1 to 1 wt %; most preferably, 0.15 to 0.6 wt %), based on weight of the laundry scenting composition, of a crosslinked cellulose ether containing 0.1 to 0.6 wt %, based on weight of the crosslinked cellulose ether, of polyether groups; wherein the crosslinked cellulose ether comprises a base cellulose ether and crosslinks; wherein the crosslinks contain the polyether groups and wherein the base cellulose ether is hydroxyethyl methylcellulose.

Preferably, the laundry scenting composition of the present invention, comprises: 0.05 to 5 wt % (preferably, 0.075 to 2 wt %; more preferably, 0.1 to 1 wt %; most preferably, 0.15 to 0.6 wt %), based on weight of the laundry scenting composition, of a crosslinked cellulose ether containing 0.1 to 0.6 wt %, based on weight of the crosslinked cellulose ether, of polyether groups; wherein the crosslinked cellulose either is an irreversibly crosslinked cellulose ether. More preferably, the laundry scenting composition of the present invention, comprises: 0.05 to 5 wt % (preferably, 0.075 to 2 wt %; more preferably, 0.1 to 1 wt %; most preferably, 0.15 to 0.6 wt %), based on weight of the laundry scenting composition, of a crosslinked cellulose ether containing 0.1 to 0.6 wt %, based on weight of the crosslinked cellulose ether, of polyether groups; wherein the crosslinked cellulose ether comprises a base cellulose ether and crosslinks; wherein the crosslinks contain the polyether groups; wherein the base cellulose ether is a mixed cellulose ether containing hydroxyalkyl ether groups and alkyl ether groups and wherein the crosslinked cellulose either is an irreversibly crosslinked cellulose ether. Still more preferably, the laundry scenting composition of the present invention, comprises: 0.05 to 5 wt % (preferably, 0.075 to 2 wt %; more preferably, 0.1 to 1 wt %; most preferably, 0.15 to 0.6 wt %), based on weight of the laundry scenting composition, of a crosslinked cellulose ether containing 0.1 to 0.6 wt %, based on weight of the crosslinked cellulose ether, of polyether groups; wherein the crosslinked cellulose ether comprises a base cellulose ether and crosslinks; wherein the crosslinks contain the polyether groups; wherein the base cellulose ether is selected from the group consisting of hydroxyethyl methylcellulose, hydroxypropyl methyl cellulose, methyl hydroxyethyl hydroxypropylcellulose, ethyl hydroxyethyl cellulose and combinations thereof and wherein the crosslinked cellulose either is an irreversibly crosslinked cellulose ether. Most preferably, the laundry scenting composition of the present invention, comprises: 0.05 to 5 wt % (preferably, 0.075 to 2 wt %; more preferably, 0.1 to 1 wt %; most preferably, 0.15 to 0.6 wt %), based on weight of the laundry scenting composition, of a crosslinked cellulose ether containing 0.1 to 0.6 wt %, based on weight of the crosslinked cellulose ether, of polyether groups; wherein the crosslinked cellulose ether comprises a base cellulose ether and crosslinks; wherein the crosslinks contain the polyether groups; wherein the base cellulose ether is hydroxyethyl methylcellulose and wherein the crosslinked cellulose either is an irreversibly crosslinked cellulose ether.

Preferably, the crosslinked cellulose ether contains 0.1 to 0.6 wt % (preferably, 0.12 to 0.6 wt %; more preferably, 0.12 to 0.45 wt %; most preferably, 0.12 to 0.29 wt %), based on weight of the crosslinked cellulose ether, of polyether groups. More preferably, the crosslinked cellulose ether contains 0.1 to 0.6 wt % (preferably, 0.12 to 0.6 wt %; more preferably, 0.12 to 0.45 wt %; most preferably, 0.12 to 0.29 wt %), based on weight of the crosslinked cellulose ether, of polyether groups; wherein the polyether groups are polyoxyalkylene groups having 2 to 100 (preferably, 2 to 20; more preferably, 3 to 15) oxyalkylene groups per crosslink. Most preferably, the crosslinked cellulose ether contains 0.1 to 0.6 wt % (preferably, 0.12 to 0.6 wt %; more preferably, 0.12 to 0.45 wt %; most preferably, 0.12 to 0.29 wt %), based on weight of the crosslinked cellulose ether, of polyether groups; wherein the polyether groups are polyoxypropylene groups having 2 to 100 (preferably, 2 to 20; more preferably, 3 to 15) oxypropylene groups per crosslink.

Preferably, crosslinked cellulose ether comprises a base cellulose ether having crosslinks containing 0.1 to 0.6 wt %, based on weight of the crosslinked cellulose ether, of polyether groups. Preferably, the base cellulose ether is selected from hydroxyalkyl cellulose ethers, alkyl cellulose ethers and combinations thereof. Examples of base cellulose ethers include, for example, methylcellulose, ethylcellulose, propylcellulose, butylcellulose, hydroxyethyl methylcellulose, hydroxypropyl methylcellulose, hydroxyethylcellulose, ethylhydroxyethylcellulose, methylethylhydroxyethylcellulose, hydrophobically modified ethylhydroxyethylcellulose, hydrophobically modified hydroxyethylcellulose, sulfoethyl methylhydroxyethylcellulose, sulfoethyl methylhydroxypropylcellulose and sulfoethyl hydroxyethylcellulose. Preferably, the base cellulose ethers are mixed cellulose ethers that contain both hydroxyalkyl ether groups and alkyl ether groups, such as, alkyl hydroxyethyl cellulose and hydroxyalkyl methylcellulose (e.g., hydroxyethyl methylcellulose, hydroxypropyl methylcellulose, methyl hydroxyethyl hydroxypropylcellulose and ethylhydroxyethyl cellulose).

Preferably, the base cellulose ether contains hydroxyalkyl ether substitutions. More preferably, the base cellulose ether has a degree of hydroxyethyl ether substitutions, MS (HE), or hydroxypropyl ether substitutions, MS (HP), of 1.5 to 4.5 (preferably, 2.0 to 3.0).

Preferably, the base cellulose ether contains methyl ether substitutions. More preferably, the base cellulose ether has a degree of methyl ether substitution, DS (M), of 1.2 to 2.1 (preferably, 1.3 to 1.7; more preferably, 1.35 to 1.60).

Preferably, the base cellulose ether is a mixed cellulose ether containing hydroxyalkyl ether substitutions and alkyl ether substitutions. More preferably, the base cellulose ether is a mixed cellulose ether having a degree of hydroxyethyl ether substitution, MS (HE), of 0.05 to 0.75 (preferably, 0.15 to 0.45; more preferably, 0.20 to 0.40) and a degree of methyl ether substitution, DS (M), of 1.2 to 2.1 (preferably, 1.3 to 1.7, more preferably, 1.35 to 1.60).

Preferably, the base cellulose ether is a mixed cellulose ether containing hydroxyalkyl ether substitutions and alkyl ether substitutions. More preferably, the base cellulose ether is a mixed cellulose ether having a degree of hydroxypropyl ether substitution, MS (HP), of 0.1 to 1.5 (preferably, 0.2 to 1.2) and a degree of methyl ether substitution, DS (M), of 1.2 to 2.1 (preferably, 1.3 to 2.0).

Preferably, the crosslinked cellulose ether comprises a base cellulose ether having crosslinks containing 0.1 to 0.6 wt %, based on weight of the crosslinked cellulose ether, of polyether groups; wherein the base cellulose ether is a hydroxyethyl methyl cellulose and wherein the crosslinks are polyoxypropylene dioxyethylene ether crosslinks, such as those produced as the reaction product of hydroxyethyl methyl cellulose with polypropylene glycol (PPG) glycidylether.

Crosslinking agents used to crosslink the base cellulose ether to form the crosslinked cellulose ether include compounds having a polyoxyalkylene or polyalkylene glycol group and two or more (preferably, two) crosslinking groups, such as, halogen groups, glycidyl or epoxy groups, and ethylenically unsaturated groups (e.g., vinyl groups) that form ether bonds with the base cellulose ether to form the crosslinked cellulose ether. Preferably, the crosslinking agent is selected from the group consisting of 1,2-dichloro(poly)alkoxy ethers, dichloropolyoxyethylene, diglycidyl polyalkoxy ethers, diglycidyl phosphonate, divinyl polyoxyalkylenes containing a sulphone group. Crosslinking agents having two different types of functional groups can be used. Examples include diglycidyl polyoxypropylenes and glycidyl(poly)oxyalkyl methacrylate. Preferably, the crosslinking agent contains 2 to 100 (preferably, 2 to 20; more preferably, 3 to 15) oxyalkylene groups per molecule.

Preferably, the amount of crosslinking agent included in the crosslinked cellulose ether ranges from 0.0001 to 0.05 eq (preferably, 0.0005 to 0.01 eq; more preferably, 0.001 to 0.005 eq), wherein the unity “eq” represents the molar ratio of moles of the crosslinking agent relative to the number of moles of anhydroglucose units (AGU) in the base cellulose ether.

Preferably, the crosslinked cellulose ether is an irreversibly crosslinked cellulose ether. That is, the crosslinks in the crosslinked cellulose ether do not break down during the intended use of the crosslinked cellulose ether under normal conditions. In contrast, reversible crosslinks will break down during the intended use of the crosslinked cellulose ether under normal conditions. An example of reversible crosslinks in cellulose ethers intended for use in detergent formulations are those created using aldehyde based crosslinkers (e.g., glyoxal), which crosslinks break down upon dissolution of the crosslinked material in water.

Preferably, the laundry scenting composition of the present invention comprises <0.5 wt % (preferably, <0.01 wt %; more preferably, <0.001 wt %; still more preferably, <0.0001 wt %; most preferably, <the detectable limit), based on weight of the detergent formulation, of crosslinked carboxymethylcellulose.

Preferably, the laundry scenting composition of the present invention, comprises 1 to 25 wt % (preferably, 2 to 20 wt %; more preferably, 4 to 18 wt %; most preferably, 6 to 15 wt %), based on weight of the laundry scenting composition, of a scent additive; wherein the scent additive is selected from the group consisting of a free perfume, a pro-perfume, an encapsulated perfume and mixtures thereof. More preferably, the laundry scenting composition of the present invention, comprises 1 to 25 wt % (preferably, 2 to 20 wt %; more preferably, 4 to 18 wt %; most preferably, 6 to 15 wt %), based on weight of the laundry scenting composition, of a scent additive; wherein the scent additive includes a mixture of a free perfume and an encapsulated perfume. Most preferably, the laundry scenting composition of the present invention, comprises: 2 to 12 wt %, based on weight of the laundry scenting composition, of a free perfume and 2 to 12 wt %, based on weight of the laundry scenting composition, of an encapsulated perfume.

The term “perfume” used herein and in the appended claims refers to an odoriferous material that is released from the laundry scenting composition of the present invention into at least one of (a) the wash water used to clean laundry, (b) the rinse water used to clean laundry and (c) the laundry contacted with (a) or (b). The perfume used in the laundry scenting composition will typically be a liquid a ambient temperatures. A range of substances are known for use as perfumes including, for example, aldehydes, ketones and esters. Naturally occurring plant and animal oils and exudates comprised of complex mixtures of components are known for use as perfumes. Perfumes may comprises woody/earthy bases with exotic materials including sandalwood, civet and patchouli oil. The perfume may be of a light floral fragrance such as rose extract, lilac and violet extract. The perfume may provide fruity odors such as lime, lemon and orange. The perfume may deliver an aromatherapy effect, such as providing a relaxing or invigorating mood.

The term “pro-perfume” used herein and in the appended claims refers to a perfume precursor that releases a desirable odor and/or perfume molecule through the breaking of a chemical bond. Typically a pro-perfume is a desired perfume raw material chemically linked to a carrier (preferably, wherein the carrier is slightly or sparingly volatile). The pro-perfume is frequently designed to increase deposition onto a fabric article. The perfume is subsequently released through breaking of the bond between the perfume raw material and the carrier through a change in pH (e.g., exposure to perspiration), moisture in the environment, heat, enzymatic action, exposure to sunlight during storage or line drying.

The term “free perfume” used herein and in the appended claims refers to perfume that contains less than 0.1 wt %, based on weight of the perfume, of a perfume carrier; wherein the perfume carrier is selected from the group consisting of cyclodextrin, zeolites and combinations thereof.

The term “encapsulated perfume” used herein and in the appended claims refers to perfume that is encapsulated. The encapsulated perfume can be friable or moisture activated. Preferably, the encapsulated perfume comprises a perfume encapsulated by a melamine/formaldehyde shell. Encapsulated perfumes are commercially available from, for example, Appleton, Quest International and International Flavor & Fragrances.

Preferably, the laundry scenting composition of the present invention, further comprises: a drainage aid component (preferably, 0.008 to 5 wt % (more preferably, 0.009 to 0.09 wt %; still more preferably, 0.01 to 0.05 wt %; most preferably, 0.02 to 0.04 wt %), based on weight of the laundry scenting composition, of the drainage aid component); wherein the drainage aid component comprises: (i) 40 to 99 wt % (preferably, 55 to 99 wt %; more preferably, 65 to 98 wt %; most preferably, 77 to 97 wt %), based on weight of the drainage aid component, of an organopolysiloxane comprising: 0 to 60 mol % of units of formula I and 40 to 100 mol % of units of formula II

Rₓ¹SiO_{(4-x)/2} (I)

R_{y}¹R_{z}²SiO_{(4-y-z)/2} (II)

wherein x is selected from the group consisting of 0, 1, 2 and 3; wherein y is selected from the group consisting of 0, 1 and 2; wherein z is selected from the group consisting of 1 and 2; with the proviso that y+z is 1, 2 or 3; wherein each R¹ is independently selected from a hydrogen, a hydroxy group and a group having 1 to 8 carbon atoms; wherein each R² is an -A_{c}R³ group; wherein A is a divalent linking group; wherein c is selected from the group consisting of 0 and 1; wherein each R³ is independently selected from a group having 9 to 35 carbon atoms; (ii) 1 to 30 wt % (preferably, 1 to 25 wt %; more preferably, 2 to 20 wt %; most preferably, 3 to 15 wt %), based on weight of the drainage aid component, of an organosilicon resin; and (iii) 0 to 30 wt % (preferably, 0 to 20 wt %; more preferably, 0 to 15 wt %; most preferably, 0 to 8 wt %), based on weight of the drainage aid component, of a hydrophobic additive.

Preferably, the drainage aid component comprises: 40 to 99 wt % (preferably, 55 to 99 wt %; more preferably, 65 to 98 wt %; most preferably, 77 to 97 wt %), based on weight of the drainage aid component, of an organopolysiloxane; wherein the organopolysiloxane comprises: 0 to 60 mol % of units of formula I and 40 to 100 mol % of units of formula II

Rₓ¹SiO_{(4-x)/2} (I)

R_{y}¹R_{z}²SiO_{(4-y-z)/2} (II)

wherein x is selected from the group consisting of 0, 1, 2 and 3; wherein y is selected from the group consisting of 0, 1 and 2 (preferably, 0 and 1; more preferably, 1); wherein z is selected from the group consisting of 1 and 2 (preferably, 1); with the proviso that y+z is 1, 2 or 3 (preferably, 2); wherein each R¹ is independently selected from a hydrogen, a hydroxy group and a group having 1 to 8 carbon atoms (preferably, a C₁₋₄ alkyl group; more preferably, a C₁₋₂ alkyl group; most preferably, a methyl group)(preferably, wherein <one R¹ per Si is a hydroxy group); wherein each R² is an -A_{c}R³ group; wherein A is a divalent linking group; wherein c is selected from the group consisting of 0 and 1 (preferably, 0); wherein each R³ is independently selected from a group having 9 to 35 carbon atoms (preferably, 10 to 30 carbon atoms; more preferably, 10 to 20 carbon atoms; most preferably, 10 to 15 carbon atoms)(preferably, wherein each R³ contains 0 to 1 oxygen atoms; more preferably, wherein each R³ contains no oxygen atoms)(preferably, wherein each R³ contains 0 nitrogen atoms)(preferably, wherein at least 50 mol % (preferably, 65 to 100 mol %; more preferably, 70 to 100 mol %; most preferably, 75 to 100 mol %) of the units of formula II in the organopolysiloxane contain at least one R²). More preferably, the drainage aid component, comprises: 40 to 99 wt % (preferably, 55 to 99 wt %; more preferably, 65 to 98 wt %; most preferably, 77 to 97 wt %), based on weight of the drainage aid component, of an organopolysiloxane; wherein the organopolysiloxane is a linear organopolysiloxane of formula III

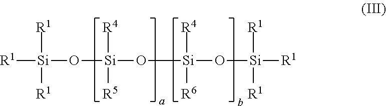

wherein each R¹ is independently selected from a hydrogen, a hydroxy group and a group having 1 to 8 carbon atoms (preferably, a C₁₋₄ alkyl group; more preferably, a C₁₋₂ alkyl group; most preferably, a methyl group)(preferably, wherein ≤one R¹ per Si is a hydroxy group); wherein each R⁴ is independently selected from the group consisting of a hydrogen, a group having 1 to 8 carbon atoms, an R⁵ and an R⁶ (preferably, wherein each R⁴ is independently selected from a hydrogen and a group having 1 to 8 carbon atoms; more preferably, wherein each R⁴ is independently selected from a C₁₋₄ alkyl group; still more preferably, wherein each R⁴ is independently selected from a C₁₋₂ alkyl group; most preferably, wherein each R⁴ is a methyl group); wherein each R⁵ is independently selected from an acyclic group having 9 to 35 carbon atoms (preferably, 10 to 30 carbon atoms; more preferably, 10 to 20 carbon atoms; most preferably, 10 to 15 carbon atoms)(preferably, wherein each R⁵ contains 0 to 1 oxygen atoms; more preferably, wherein each R⁵ contains no oxygen atoms)(preferably, wherein each R⁵ contains 0 nitrogen atoms); wherein each R⁶ is independently selected from an alkylaryl group; wherein a is 10 to 500; wherein b is 0 to 250 and wherein a+b is 10 to 500 (preferably, 25 to 250; more preferably, 30 to 100; most preferably, 45 to 75)(preferably, wherein a≥b; more preferably, wherein a>b)(preferably, wherein ≥60 mol % (preferably, ≥65 mol %; more preferably, ≥70 mol %; most preferably, ≥75 mol %) of the Si atoms in the linear organopolysiloxane of formula I have an R⁵ group attached)(preferably, wherein b=0). Most preferably, the drainage aid component, of the present invention, comprises: 40 to 99 wt % (preferably, 55 to 99 wt %; more preferably, 65 to 98 wt %; most preferably, 77 to 97 wt %), based on weight of the drainage aid component, of an organopolysiloxane; wherein the organopolysiloxane is a linear organopolysiloxane of formula III; wherein each R¹ is independently selected from a hydrogen, a hydroxy group and a group having 1 to 8 carbon atoms (preferably, a C₁₋₄ alkyl group; more preferably, a C₁₋₂ alkyl group; most preferably, a methyl group)(preferably, wherein <one R per Si is a hydroxy group); wherein each R⁴ is independently selected from the group consisting of a hydrogen, a group having 1 to 8 carbon atoms, an R⁵ and an R⁶ (preferably, wherein each R⁴ is independently selected from a hydrogen and a group having 1 to 8 carbon atoms; more preferably, wherein each R⁴ is independently selected from a C₁₋₄ alkyl group; still more preferably, wherein each R⁴ is independently selected from a C₁₋₂ alkyl group; most preferably, wherein each R⁴ is a methyl group); wherein each R⁵ is an -A_{c}R⁷ group; wherein each R⁷ is independently selected from an acyclic group having 9 to 35 carbon atoms (preferably, an acyclic C₁₀₋₃₀ alkyl group; more preferably, an acyclic C₁₀₋₂₀ alkyl group; most preferably, an acyclic C₁₀₋₁₅ alkyl group)(preferably, wherein each R⁷ is a hydrocarbyl group); wherein c is selected from the group consisting of 0 and 1 (preferably, wherein c is 0); and wherein A is a divalent linking; wherein each R⁶ is a —YR⁸ group; wherein Y is selected from the group consisting of a divalent alkylene group having 2 to 10 (preferably, 2 to 4; more preferably, 2) carbon atoms and 0 to 2 (preferably, 0 to 1; more preferably, 0) oxygen atoms; and wherein R⁸ is at least one —C₆R⁹₆ aromatic ring; wherein each R⁹ is independently selected from a hydrogen, a halogen, a hydroxyl, a C₁₋₆ alkoxy group, a C₁₋₁₂ alkyl group or wherein two or more R⁹ groups together represent a divalent hydrocarbon group joining together two or more aromatic rings (preferably, wherein each R⁶ is independently selected from the group consisting of styrene, α-methyl styrene, eugenol, allylbenzene, allyl phenyl ether, 2-allylphenol, 2-chlorostyrene, 4-chlorostyrene, 4-methylstyrene, 3-methylstyrene, 4-t-butylstyrene, 2,4-dimethylstyrene, 2,5-dimethylstyrene, 2,4,6-trimethylstyrene and mixtures thereof; most preferably, α-methyl styrene); wherein a is 10 to 500; wherein b is 0 to 250 and wherein a+b is 10 to 500 (preferably, 25 to 250; more preferably, 30 to 100; most preferably, 45 to 75)(preferably, wherein a≥b; more preferably, wherein a>b)(preferably, wherein ≥60 mol % (preferably, ≥65 mol %; more preferably, ≥70 mol %; most preferably, ≥75 mol %) of the Si atoms in the linear organopolysiloxane of formula III have an R⁵ group attached)(preferably, wherein b=0).

Preferably, the organopolysiloxane of the drainage aid component has a degree of polymerization of 10 to 500. More preferably, the organopolysiloxane of the drainage aid component has a degree of polymerization of 25 to 250. Still more preferably, the organopolysiloxane of the drainage aid component has a degree of polymerization of 30 to 100. Most preferably, the organopolysiloxane of the drainage aid component has a degree of polymerization of 45 to 75.

Preferably, the organopolysiloxane of the drainage aid component is a linear organopolysiloxane; wherein the linear organopolysiloxane comprises <0.1 wt % (preferably, <0.01 wt %; more preferably, <0.001 wt %; most preferably, <detectable limit) of trifunctional siloxane units. Preferably, the organopolysiloxane of the drainage aid component is a linear organopolysiloxane; wherein the linear organopolysiloxane comprises <0.1 wt % (preferably, <0.01 wt %; more preferably, <0.001 wt %; most preferably, <the detectable limit) of trifunctional siloxane units; and wherein the linear organopolysiloxane comprises <the detectable limit of aromatic moieties (e.g., α-methyl styrene moieties).

The divalent linking group, A, when present in the organopolysiloxane of the drainage aid component, preferably consists of (i) oxygen; (ii) carbon and hydrogen; or (iii) carbon, hydrogen, oxygen and optionally nitrogen, sulfur and/or phosphorus. Oxygen when present in the divalent linking group, A, is selected from the group consisting of an ether oxygen, an ester oxygen, a substituted hydroxyl, a substituted alkoxy group and a combination thereof. Nitrogen when present in the divalent linking group, A, is selected from the group consisting of an amino group, an amido group and combinations thereof. The divalent linking group, A, when present in the organopolysiloxane is preferably selected from the group consisting of alkylene ester groups, alkylene ether groups, amide groups, polyamino/amido groups and mercapto groups, such as, —O—, —CH₂CH₂OC(═O)—, —CH₂CH₂OCH₂CH(OH)—, —(CH₂)₃NHC(═O)—, —(CH₂)₃NHCH₂C(═O)—, —CH₂CH₂S— and

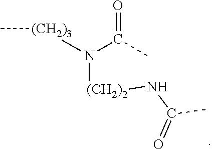

Preferably, the organopolysiloxane of the drainage aid component is nonionic.

Preferably, the drainage aid component comprises: 1 to 30 wt % (preferably, 1 to 25 wt %; more preferably, 2 to 20 wt %; most preferably, 3 to 15 wt %), based on weight of the drainage aid component, of an organosilicon resin; wherein the organosilicon resin is comprised primarily of R₃¹⁰SiO_{1/2} and SiO_{4/2} units (i.e., M and Q units, respectively); wherein each R¹⁰ is selected from the group consisting of a functional or non-functional, substituted or unsubstituted monovalent radical (preferably, a hydroxyl group, a hydrocarbon group and a hydrocarbonoxy group). The number ratio of the M groups to Q groups is preferably 0.4:1 to 2.5:1 (more preferably, 0.4:1 to 1.5:1; most preferably, 0.5:1 to 1.1:1). While the organosilicon resin preferably contains only M and Q units, the organosilicon resin may include a limited number of R₂¹⁰SiO_{2/2} and R¹⁰SiO_{3/2} units (i.e., D and T units, respectively). Preferably, the organosilicon resin is an MQ silicone resin. As used herein, the term “MQ silicone resin” means that, on average, no more than 20 mole percent (preferably, no more than 15 mole percent; more preferably, no more than 10 mole percent; still more preferably, no more than 5 mole percent; most preferably, no more than 1 mole percent) of the organosilicon units are comprised of D and T units.

Preferably, the drainage aid component comprises: 0 to 30 wt % (preferably, 0 to 20 wt %; more preferably, 0 to 15 wt %; most preferably, 0 to 8 wt %), based on weight of the drainage aid component, of a hydrophobic additive; wherein hydrophobic additive is selected from the group consisting of silica, titania, alumina, ground quartz, magnesium oxide, zinc oxide, salts of aliphatic carboxylic acids (e.g., calcium or aluminum stearates), reaction products of isocyanates with certain cyclohexylamine and alkyl amides (e.g., ethylene or methylene bis stearamide). More preferably, the drainage aid component comprises: 0 to 30 wt % (preferably, 0 to 20 wt %; more preferably, 0 to 15 wt %; most preferably, 0 to 8 wt %), based on weight of the drainage aid component, of a hydrophobic additive; wherein the hydrophobic additive is selected from silica particles. Most preferably, the drainage aid component comprises: 0 to 30 wt % (preferably, 0 to 20 wt %; more preferably, 0 to 15 wt %; most preferably, 0 to 8 wt %), based on weight of the drainage aid component, of a hydrophobic additive; wherein hydrophobic additive is selected from silica particles having an average particle size of 0.1 to 50 μm (preferably, 1 to 20 μm) and a surface area of at least 50 m²/g. The silica particles may be rendered hydrophobic, e.g., by treating with dialkylsilyl groups and/or trialkylsilyl groups either bonded directly onto the silica or by means of a silicone resin. Preferably, the silica particles are rendered hydrophobic with dimethyl and/or trimethyl silyl groups. The silica materials may be selected from fumed silica, precipitated silica, hydrothermal silica and gel formation silica.

Preferably, the drainage aid component contains <0.1 wt %, based on weight of the drainage aid component, of a hydrophobic particulate material (e.g., silica, titania, alumina, ground quartz, magnesium oxide, zinc oxide, salts of aliphatic carboxylic acids (e.g., calcium or aluminium stearates), reaction products of isocyanates with certain materials (for example cyclohexylamine and alkyl amides, e.g., ethylene or methylene bis stearamide).

Preferably, the drainage aid component optionally contains an optional material selected from the group consisting of a binder/encapsulant (e.g., a polyacrylic binder), a surfactant and a solid support.

Binders/encapsulants used in the drainage aid component may include polyoxyalkylene polymers (e.g., polyethylene glycol, which can be applied molten or as an aqueous solution and spray dried); reaction products of tallow alcohol and ethylene oxide or polypropylene glycol; polycarboxylates (e.g., polyacrylic acid, partial sodium salts of polyacrylic acid, copolymers of acrylic acid and maleic anhydride); cellulose ethers (e.g., sodium carboxymethylcellulose); gelatin; agar; microcrystalline waxes; fatty acids or fatty alcohols having 12 to 20 carbon atoms and a melting point in the range 45 to 80° C.; a monoester of glycerol with such a fatty acid; a mixture of a water insoluble wax having a melting point of 55 to 100° C. and a water-insoluble emulsifying agent, glucose or hydrogenated glucose.

Surfactant used in the drainage aid component can be selected to facilitate dispersal of the organopolysiloxane from the binder/encapsulant. Silicone glycols are preferred surfactants for use in combination with many binder/encapsulants. Fatty alcohol ether sulphates or linear alkylbenzene sulphonates are preferred for use in combination with polyacrylic acid type binder/encapsulants. The surfactant may be added to the organopolysiloxane of the drainage aid component undiluted or in emulsion before the organopolysiloxane is mixed with the binder/encapsulant, or the surfactant and the organopolysiloxane may successively be added to the binder/encapsulant.

Solid support used in the drainage aid component is preferably selected from zeolites (e.g. Zeolite A, Zeolite X), aluminosilicates, silicates (e.g., magnesium silicate), phosphates (e.g., powdered or granular sodium tripolyphosphate), sodium sulphate, sodium carbonate, sodium perborate, a cellulose derivative (e.g., sodium carboxymethylcellulose), granulated starch, clay, sodium citrate, sodium acetate, sodium bicarbonate and native starch.

Preferably, the laundry scenting composition of the present invention, further comprises an optional ingredient selected from the group consisting of a dye, a particulate spacer, a foam regulator and mixtures thereof.

Preferably, the laundry scenting composition of the present invention, optionally further comprises 0 to 0.1 wt % (preferably, 0.001 to 0.1 wt %; more preferably, 0.01 to 0.02 wt %), based on weight of the laundry scenting composition, of a dye. Dyes used in the solid laundry drainage aid laundry scenting composition may include those typically used in laundry treating products (e.g., detergent, fabric softener).

The laundry scenting composition of the present invention, optionally further comprises a particulate spacer material. More preferably, the laundry scenting composition of the present invention, optionally further comprises a particulate spacer material; wherein 0 to 50 wt % (preferably, 0 to 45 wt %; more preferably, 0 to 40 wt %) of the solid carrier is replaced by the particulate spacer material. Preferably, the laundry scenting composition of the present invention, optionally further comprises a particulate spacer material; wherein 0 to 50 wt % (preferably, 0 to 45 wt %; more preferably, 0 to 40 wt %) of the solid carrier is replaced by the particulate spacer material; wherein the particulate spacer material has a mean particle size of 55 to 750 microns (preferably, 75 to 650 microns; more preferably, 95 to 600 microns; most preferably, 100 to 250 microns). Preferably, the particulate spacer material is non-water soluble or exhibits a water dissolution rate significantly lower than that of the solid carrier (i.e., wherein the dissolution rate of the solid carrier divided by the dissolution rate of the particulate spacer material is at least 2). Preferably, the particulate spacer material occupies 0 to 0.5 vol % (preferably, 0.1 to 0.5 vol %; more preferably, 0.15 to 0.45 vol %; most preferably, 0.2 to 0.45 vol %) of the laundry scenting composition of the present invention. The particulate spacer material may have a variety of shapes including spherical, polyhedron, granule, fibrillar and crystalline. Preferably, the particulate spacer material is a solid over the temperature range of 25 to 70° C. The particulate spacer material is preferably selected from the group consisting of organic particulate material, inorganic particulate material and combinations thereof. Preferably, the particulate spacer material is selected from the group consisting of alkali metal borates (e.g., sodium borate, sodium tetraborate, disodium tetraborate, potassium tetraborate); glass microspheres (e.g., soda lime glass microspheres, hollow glass microspheres, borosilicate solid glass microspheres); polyalkylene microspheres (e.g., polyethylene microspheres, polypropylene microspheres); ceramic microspheres and mixtures thereof.

Preferably, the laundry scenting composition of the present invention, optionally further comprises a foam regulator. More preferably, the laundry scenting composition of the present invention, optionally further comprises a foam regulator; wherein the foam regulator is selected from the group consisting of organomodified silicones, polydimethyl silicones and fatty acids. Most preferably, the laundry scenting composition of the present invention, optionally further comprises a foam regulator; with the proviso that when the foam regulator is an organomodified silicone, said organomodified silicone is compositionally different from that included in the drainage aid component.

Preferably, the laundry scenting composition of the present invention contains <3 wt % (preferably, <2 wt %; more preferably, <1 wt %; still more preferably, <0.1 wt %; yet more preferably, <0.01 wt %; most preferably, <0.0001 wt %) laundry actives. Laundry actives include, for example, detergent surfactants, detergent builders, bleaching agents, enzymes and mixtures thereof. A non-detersive level of surfactant may be used to facilitate solubilization of the drainage aid component in the solid carrier.

Preferably, the laundry scenting composition of the present invention is provided as a pastille (more preferably, as a plurality of pastilles). More preferably, the laundry scenting composition of the present invention is provided as a pastille (more preferably, as a plurality of pastilles) having a shape selected from the group consisting of tablets, polyhedrons, granules, spheres, hemispheres, compressed hemispheres, lentils and oblong shape (preferably, hemispheres and compressed hemispheres). Most preferably, the laundry scenting composition of the present invention is provided as a plurality of pastilles having a compressed hemispherical shape. The term “compressed hemispherical” as used herein and in the appended claims refers to a shape corresponding to a hemisphere that is at least partially flattened, whereby the radius of the compressed hemisphere is shorter along an axis tangential to the flattened surface relative to the radius of the compressed hemisphere along an axis along the flattened surface. Preferably, the compressed pastilles have a ratio of height to diameter of 0.01 to 0.4 (preferably, 0.1 to 0.4; more preferably, 0.2 to 0.3). Preferably, the individual pastilles have a volume of 0.003 to 0.15 cm³. Preferably, the pastilles have a weight of 0.95 mg to 2 g. Preferably, a plurality of pastilles collectively comprise a unit dose for dosing to a laundry washing machine or a laundry wash basin. Preferably, a unit does of the laundry scenting composition of the present invention comprises 2 to 40 g (preferably, 3 to 35 g; more preferably, 4 to 30 g; most preferably, 5 to 28 g) of pastilles.

Preferably, the laundry scenting composition of the present invention is provided in a package containing a single unit dose or a plurality of unit doses. The package may be selected from the group consisting of a bottle, a bag or other suitable container. Preferably, the package is a PET bottle.

Preferably, the package containing the laundry scenting composition of the present invention comprises a dosing means for measuring and dispensing the laundry scenting composition to a washing machine or wash basin. Examples of dosing means include a dispensing cap or dome that is functionally attached to the package. The dosing means may be releasably detachable from and reatachable to the package.

Preferably, the method of making the laundry scenting composition of the present invention comprises: providing a solid carrier (preferably, wherein the solid carrier has a melting point above 25° C.)(preferably, wherein the solid carrier is a polyethylene glycol having a melting point above 25° C.); providing a crosslinked cellulose ether containing 0.1 to 0.6 wt %, based on weight of the crosslinked cellulose ether, of polyether groups; providing water; providing a scent additive; optionally providing a drainage aid component; melting the solid carrier (preferably, wherein the solid carrier is heated to a temperature above its melting point); mixing the crosslinked cellulse ether with water to form a blend; adding the blend to the molten solid carrier to form a mixture; adding the scent additive to the mixture; optionally adding the drainage aid component, if any, and any other optional ingredients (e.g., dyes, particular spacers, foam regulators) with the heated mixture to form a melt composition; and cooling the melt composition (preferably to a temperature below the melting point temperature for the solid carrier) to form a non-porous water dissolvable (or dispersible) solid (e.g., plurality of pastilles) using well known techniques.

Preferably, the method of scenting laundry of the present invention, comprises: dosing to a laundry washing machine or a laundry wash basin (preferably, to a laundry washing machine) a laundry scenting composition according to the present invention (optionally, other fabric care products can be dosed to the laundry washing machine or the laundry wash basin, e.g., laundry detergent, fabric softener); adding laundry (preferably, wherein the laundry comprises fabric articles, wherein the fabric articles are selected from a cotton fabric and a polyester cotton blend fabric; more preferably, wherein the laundry comprises fabric articles, wherein the fabric articles comprise a cotton fabric) to the laundry washing machine or the laundry wash basin (preferably, to the laundry washing machine); dosing water to the laundry washing machine or the laundry wash basin (preferably, to the laundry washing machine); and applying the water and the laundry scenting composition to the laundry; wherein the scent additive comprises a perfume which is applied to the laundry.

Some embodiments of the present invention will now be described in detail in the following Examples.

### Synthesis 1: Crosslinked Cellulose Ether

The crosslinking agent used in Synthesis 1 was a linear poly(propyleneglycol) diglycidyl ether made from polypropylene glycol (PPG) having a molecular weight of ˜400 Daltons and having the formula

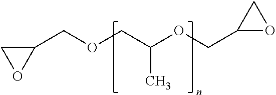

wherein n is 5.7 to 6.7 (available from Leuna-Harze GmbH, Leuna, DE as EPILOX™ M985 poly(propyleneglycol) diglycidylether crosslinker).

Ground cellulose flock (1.5 mol) was added to a 5 L autoclave. After purging the autoclave trice with nitrogen gas, the contents of the autoclave were heated to 40° C. Then dimethylether (DME, 4.7 mol/mol of anhydroglucose units (AGU)) and methyl chloride (MCl; 3.2 mol/mol AGU) were injected into the autoclave. Causting soda (NaOH, strength 50 wt % aqueous, 1.9 mol NaOH/mol AGU) was added to the autoclave in 3 portions during 2 minutes at a temperature of 40° C. The reaction mixture was held at 40° C. for 30 minutes. Ethylene oxide (0.45 mol/mol AGU) was then added and the reaction mixture was held for 10 minutes at 40° C. The crosslinker (EPILOX™ M985 crosslinker; 0.0025 mol/mol AGU) was dissolved in 20 mL of isopropanol and added to the contents of the autoclave in six increments in 30 second intervals. The contents of the autoclave were then heated to 80° C. in 40 minutes. At 80° C. a water soluble monovalent copper ligant (MCL 2; 1.3 mol/mol AGU) was injected into the autoclave quickly. Afterwards, NaOH (0.67 mol/mol AGU) was added in 7 portions over 30 minutes, followed by a 70 minute cook-off time at 80° C. Following this, the product crosslinked cellulose ether was washed in hot (>95° C.) water, neutralized with formic acid, granulated, dried and milled.

### Comparative Examples C₁-C₆ and Example 1-2: Laundry Scenting Composition

Solid laundry scenting compositions according to Comparative Examples C1-C6 and Examples 1-2 were prepared with the components in the amounts listed in TABLE 1 using the following procedure. The polyethylene glycol (PEG) was added to a flask and heated at 80° C. until melted. The additive was then slowly added into the molten PEG with stirring. The flask contents were then cooled to 65° C. and then the fragrance was added to the flask contents with stirring. The flask contents were then poured onto a smooth metal surface a room temperature to obtain the product solid laundry scenting composition in the form of solid flakes.

TABLE 1

| | PEG¹ | Additive | | Fragrance | |
|---|---|---|---|---|---|
| Ex. | (g) | Description | (g) | A | B |
| C1 | 35 | 1 wt % aqueous silicate² soln | 10 | 5 | — |
| C2 | 35 | 1 wt % aqueous silicate³ soln | 10 | 5 | — |
| C3 | 35 | 1 wt % aqueous bentonite⁴ soln | 10 | 5 | — |
| C4 | 35 | deionized water | 10 | 5 | — |
| C5 | 45 | — | — | — | 5 |
| C6 | 35 | deionized water | 15 | — | 5 |
| 1 | 35 | 1 wt % aqueous soln Product of Synthesis S1 | 10 | 5 | — |
| 2 | 35 | 0.8 wt % aqueous soln Product of Synthesis | 15 | — | 5 |
| | | S1 | | | |

¹CARBOWAX ™ Polyethylene Glycol 8000 from The Dow Chemical Company
²Laponite XL21 synthetic layered silicate from Eckart Effect Pigments
³Laponite XLS synthetic layered silicate from Eckart Effect Pigments
⁴Bentonite from Amcol
A Tornado Fresh from International Flavors & Fragrances Inc.
B Planet 34 from Givaudan

### Hardness

The indentation hardness of the solid laundry scenting compositions prepared according to Comparative Examples C1-C4 and Example 1 were measured according to ASTM D 2240 using a Shore Instrument and Manufacturing Co. durometer. The average Shore A hardness of five separate measurements per solid laundry scenting composition is provided in TABLE 2.

TABLE 2

| Example | Hardness (Shore A) |
|---|---|
| C1 | 56 |
| C2 | <30 |
| C3 | <20 |
| C4 | 10 |
| 1 | 80 |

### Fragrance Delivery

Tests were run using three separate Miele W377 front loading washing machines. Each machine was loaded with 4 small terry towels, 5 pillowcases and 11 liters of water at a hardness of 27.5° french degree. Twenty grams of the solid laundry scenting composition from Comparative Examples C5-C6 and Example 2 was separately added to one of the three washing machines. The washing machines were then started using the Color program set at 40° C., short program and 600 rpm. At the end of the rinse cycle, the terry towels were removed from the washing machines. Four panelists rated perfume intensity of a terry towel treated with each of the solid laundry scenting composition of Comparative Examples C5-C6 and Example 2 both while wet from the machine and after line drying for 1 day. Each panelist assigned a value of 1 to 10 (1=lowest intensity and 10=the highest intensity) for the perfume intensity of a treated terry towel with Comparative Example C5 arbitrarily assigned a value of 5. The numbers provided in TABLE 3 represent the average of the values assigned by the four panelists for each of the treated terry towels.

TABLE 3

| | Wet | After 1 day of |
|---|---|---|
| Laundry scenting composition | towel | line drying |
| Comparative Example C5 | 5 | 5 |
| Comparative Example C6 | 7 | 6.5 |
| Example 2 | 8 | 8.3 |

We claim:

1. A laundry scenting composition, comprising:
5 to 40 wt %, based on weight of the laundry scenting composition, of water;
35 to 93.95 wt %, based on weight of the laundry scenting composition, of a solid carrier;
0.05 to 5 wt %, based on weight of the laundry scenting composition, of a crosslinked cellulose ether containing 0.1 to 0.6 wt %, based on weight of the crosslinked cellulose ether, of polyether groups; and
1 to 25 wt %, based on weight of the laundry scenting composition, of a scent additive;
wherein the laundry scenting composition is a solid.

2. The laundry scenting composition of claim 1, wherein the crosslinked cellulose ether is an irreversibly crosslinked cellulose ether.

3. The laundry scenting composition of claim 2, wherein the polyether groups in the irreversibly crosslinked cellulose ether are polyoxyalkylene groups having 2 to 100 oxyalkylene groups.

4. The laundry scenting composition of claim 3, wherein the polyoxyalkylene groups are selected from the group consisting of a polyoxyethylene, a polyoxypropylene and combinations thereof.

5. The laundry scenting composition of claim 4, wherein the irreversibly crosslinked cellulose ether comprises a base cellulose ether and crosslinks; wherein the crosslinks contain the polyether groups; and wherein the base cellulose ether contains hydroxyalkyl ether and alkyl ether groups.

6. The laundry scenting composition of claim 5, wherein the base cellulose ether is selected from the group consisting of hydroxyethyl methylcellulose, hydroxypropyl methyl cellulose, methyl hydroxyethyl hydroxypropylcellulose, ethyl hydroxyethyl cellulose and combinations thereof.

7. The laundry scenting composition of claim 2, wherein the laundry scenting composition is in the shape of a pastille.

8. The laundry scenting composition of claim 2, further comprising 0.008 to <0.1 wt %, based on weight of the laundry scenting composition, of a drainage aid component; wherein the drainage aid component comprises:
40 to 99 wt %, based on weight of the drainage aid component, of an organopolysiloxane comprising:
0 to 60 mol % of units of formula I
Rₓ¹SiO_{(4-x)/2} (I)
40 to 100 mol % of units of formula II
R_{y}¹R_{z}²SiO_{(4-y-z)/2} (II)
wherein x is selected from the group consisting of 0, 1, 2 and 3;
wherein y is selected from the group consisting of 0, 1 and 2; wherein z is selected from the group consisting of 1 and 2; with the proviso that y+z is 1, 2 or 3; wherein each R¹ is independently selected from a hydrogen, a hydroxy group and a group having 1 to 8 carbon atoms;
wherein each R² is an -A_{c}R³ group; wherein A is a divalent linking group; wherein c is selected from the group consisting of 0 and 1;
wherein each R³ is independently selected from a group having 9 to 35 carbon atoms;
1 to 30 wt %, based on weight of the drainage aid component, of an organosilicon resin; and
0 to 30 wt %, based on weight of the drainage aid component, of a hydrophobic additive.

9. The laundry scenting composition of claim 2, further comprising an optional additive selected from the group consisting of a dye, a particulate spacer, a foam regulator and mixtures thereof.

10. A method for scenting laundry comprising:
dosing to the laundry washing machine or the laundry wash basin a laundry scenting composition according to claim 1;
adding a fabric article to a laundry washing machine or a laundry wash basin;
dosing water to the laundry washing machine or the laundry wash basin; and
applying the water and the laundry scenting composition to the fabric article;
wherein the scent additive comprises a perfume which is applied to the fabric article.
